(19) United States
(12) Patent Application Publication
(10) Pub. No.: US 2024/0264613 A1
(43) Pub. Date: Aug. 8, 2024

(54) FLUID FLOW MANAGEMENT SYSTEM

(71) Applicant: Watts Regulator Co., North Andover, MA (US)

(72) Inventors: Ian David Baynes, Merrimac, MA (US); Michael R. Paquette, Morristown, NY (US)

(21) Appl. No.: 18/436,071

(22) Filed: Feb. 8, 2024

Related U.S. Application Data
(60) Provisional application No. 63/483,901, filed on Feb. 8, 2023.

(51) Int. Cl. G05D 7/06; E03B 7/00; E03B 7/07; F17D 5/00; F17D 5/02

(52) U.S. Cl. CPC G05D 7/0635; E03B 7/003; E03B 7/071; F17D 5/005; F17D 5/02

(57) ABSTRACT

The present disclosure provides a fluid flow management system that includes a flow sensor coupled to a fluid source conduit and configured to determine a fluid flow in the fluid source conduit; a flow sensor controller to compare the fluid flow to a flow threshold and generate a leak trigger signal based on the comparison of the fluid flow to the flow threshold; a controllable valve coupled to the fluid source conduit; and a valve controller to control the controllable valve to shut off the fluid flow in the fluid conduit based on a state of the leak trigger signal.

### CROSS REFERENCE TO RELATED APPLICATION

The present disclosure relates claims the benefit of U.S. Provisional Application Ser. No. 63/483,901, filed Feb. 8, 2023, which is fully incorporated herein by reference.

### TECHNICAL FIELD

The present disclosure relates to systems and methods for monitoring and managing fluid flow, for example, gas and/or water fluid flow monitoring and management.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates a fluid flow monitoring and management system consistent with several embodiments of the present disclosure;

FIG. 2 illustrates a flowchart of fluid leak detection operations according to one embodiment of the present disclosure;

FIG. 3 illustrates a flowchart of fluid shut-off operations according to one embodiment of the present disclosure;

FIG. 4 illustrates example implementations of a fluid flow management system according to embodiments of the present disclosure; and

FIG. 5 illustrates another example implementation of a fluid flow management system according to one embodiment of the present disclosure.

Although the following Detailed Description will proceed with reference being made to illustrative embodiments, many alternatives, modifications and variations thereof will be apparent to those skilled in the art.

### DETAILED DESCRIPTION

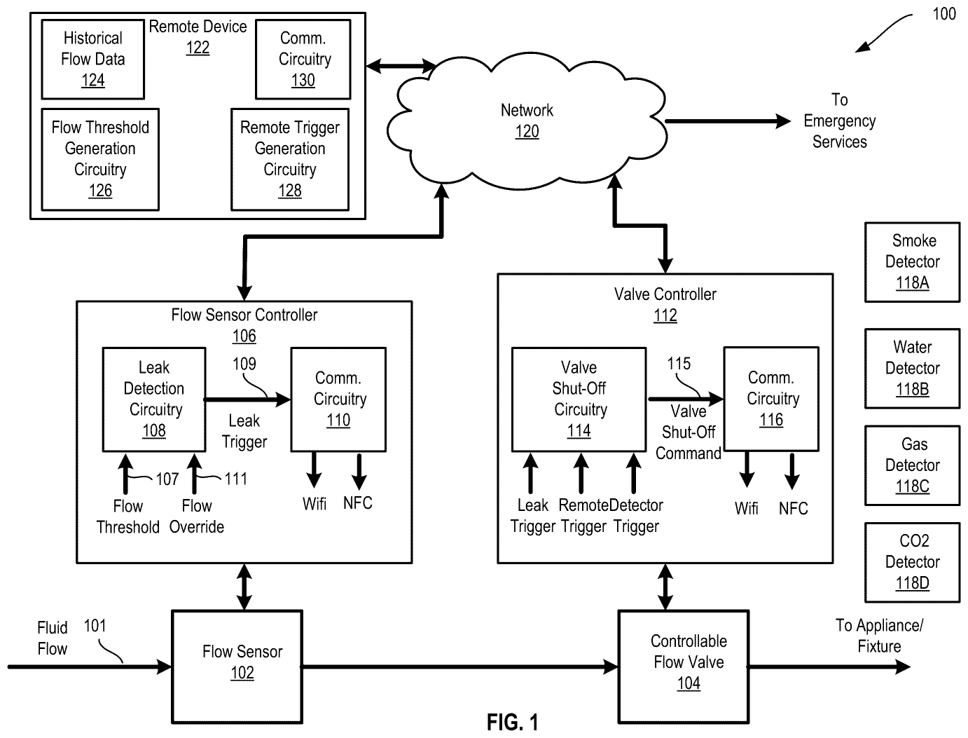

FIG. 1 illustrates a fluid flow monitoring and management system 100 consistent with several embodiments of the present disclosure. The system 100 includes a flow sensor 102 and a controllable flow valve 104 coupled to a fluid source via a fluid conduit 101 (e.g., gas pipe, water pipe, etc.). In embodiments described herein, the fluid source may include gas (e.g., natural gas, propane, etc.) and/or liquid (e.g., water, etc.) as is commonly found in residential and commercial buildings. The flow sensor 102 is generally configured to determine a fluid flow through the conduit 101 and the controllable flow valve is generally configured to shut off fluid flow in the event of a leak condition, as described herein. The system 100 of FIG. 1 may be used on a main gas supply line and/or main water supply line. The system 100 of FIG. 1 may also be used in one or more supply branches, for example, a gas supply to a household appliance, a water supply to a plumbing fixture, etc. The system 100 of FIG. 1 is generally configured for automated and/or user-controlled leak detection and fluid shut-off, as described herein.

The system 100 also includes a flow sensor controller 106 coupled to the flow sensor 102 and generally configured to monitor fluid flow in the conduit 101 to determine if a fluid leak has occurred. The flow sensor controller 106 includes leak detection circuitry 108 configured to compare a flow threshold 107 to a fluid flow through the conduit 101, as determined by the flow sensor 102, as will be described below. If fluid flow in the conduit 101 exceeds a the flow threshold 107, the leak detection circuitry 108 is also configured to generate a leak trigger signal 109 indicative of a leak in the conduit 101 and/or a leak in an appliance coupled to the conduit 101. As is understood, in normal operation, a gas appliance or plumbing fixture will cause fluid flow in the conduit 101 when the appliance/fixture is turned on. Fluid flow under these conditions may be generally considered to be much larger than fluid flow associated with a leak. Accordingly, generation of a leak trigger 109 may also be based on a flow override signal 111, where the flow override signal 111 is indicative of and/or proportional to a normal (i.e., intentional) fluid flow to a gas appliance and/or plumbing fixture. If the flow override signal 111 indicates normal, intentional operation, the leak detection circuitry 108 may disregard the flow threshold signal 107 (and therefore cancel generating a leak trigger signal 109). In other embodiments, the flow override signal 111 may be generated by an appliance/fixture that is in communication with the flow sensor controller 106, for example, an internet-of-things (IoT) appliance/fixture configured to generate a flow override signal during normal, intentional operation.

The flow sensor controller 106 may also be configured to provide fluid flow information to a remote device (122) on a continuous or periodic basis, and such information may include fluid flow at various times, leak trigger events, etc. The flow sensor controller 106 also includes communications circuitry 110 generally configured to provide communications with other devices as described herein. The communications circuitry 110 may be configured to exchange commands and data with other devices of the system 100 of FIG. 1 using conventional and/or proprietary communications protocols, for example WiFi, cellular, near-field communication (NFC) (e.g., Bluetooth, etc.).

The system 100 also includes a valve controller 112 generally configured to control an operation (shut-off operation) of the controllable flow valve 104. The valve controller 112 includes valve shut-off circuitry 114 generally configured to receive a trigger command and generate a valve shut-off command 115 to cause the controllable flow valve 104 to shut off, i.e., to stop fluid flow. The trigger command may include, for example, the leak trigger 109 as generated by the leak detection circuitry 108, a remote command as may be generated by a remote device (122) in communication with the valve controller 112, and/or a detector trigger. The detector trigger may be generated by, for example, one or more detectors in communication with the valve controller 112. The one or more detectors, as illustrated in FIG. 1, may include, for example a smoke detector 118A, a water detector 118B, gas detector 118C, CO2 detector 118D, and/or other known or after-developed detectors (such as a temperature sensor, etc.), etc. As a general matter, the detector trigger may be generated by any detector situated in or near the environment of the fluid supply such that a detector trigger indicates an adverse event that, for safety reasons, may cause a shut-off of the fluid supply. The valve controller 1112 also includes communications circuitry 116 generally configured to provide communications with other devices as described herein. The communications circuitry 116 may be configured to exchange commands and data with other devices of the system 100 of FIG. 1 using conventional and/or proprietary communications protocols, for example WiFi, cellular, near-field communication (NFC) (e.g., Bluetooth, etc.). The valve controller 112 may communicate shut-off commands with a remote device 122 to notify a user of a shut-off event. In some embodiments, a shut-event may also be communicated to emergency services (e.g., fire department, etc.).

The system 100 of FIG. 1 may also include a remote device 122 generally configured to exchange commands and data with the flow sensor controller 106 and valve controller 112. The remote device 122 may include, for example, a user device (e.g., handheld computing device such as a smart phone, laptop, etc.) to enable a user to monitor and control fluid flow. The remote device may include memory to store historical flow data 124, as received from the flow sensor controller 106. The historical flow data 124 may enable a user to identify fluid use trends and/or trigger warnings associated with fluid flow. In some embodiments, the remote device 122 may include flow threshold generation circuitry 124 configured to determine an appropriate flow threshold 107 based on, for example, the historical flow data 124, user defined and/or manufacturer supplied threshold data, etc. The flow threshold generation circuitry 124 may be configured to utilize machine learning and/or artificial intelligence techniques for determining a flow threshold 107. The remote device 122 may also include remote trigger generation circuitry 128 to enable a user to generate a remote shut-off trigger to the valve shut-off circuitry 114. For example, if a user is going on vacation, it may be desirable to enable the user to shut off water and/or gas supply to a residence, etc. The remote device 122 also includes communications circuitry 130 generally configured to provide communications with other devices as described herein. The functionality of the remote device 122 described above may be embodied as an “app” or application that may be supplied by a manufacturer of the flow sensor controller 106 and/or valve controller 112. The communications circuitry 116 may be configured to exchange commands and data with other devices of the system 100 of FIG. 1 using conventional and/or proprietary communications protocols, for example WiFi, cellular, near-field communication (NFC) (e.g., Bluetooth, etc.). The remote device 122 may communicate with the flow sensor controller 106 and valve controller 112 via network 120.

The flow threshold 107 may be based on a tolerance limit for a given appliance coupled to the fluid conduit 101. For example, a gas stove may include a pilot light requiring a small amount of gas flow to keep the pilot light ignited. In such a scenario, the flow threshold 107 may include a non-zero flow amount that is tolerated for an appliance. In other embodiments, the flow threshold 107 may be set to a zero value. For example, if the system 100 is configured to monitor and control a water supply, any flow detected by the leak detection circuitry 108 may be indicative of a burst pipe (e.g., freezing event, etc.) and/or other leak in the system, and the flow threshold 107 may be set to have a zero or very low value so that water supply can be shut off if any non-intentional flow is detected. In other embodiments, the flow threshold may be adjusted over a time period, for example throughout a day based on the historical flow data 124. For example, water and/or gas flows may demonstrate a daily flow pattern during normal (intentional) use. Such patterns may be used by the flow threshold generation circuitry 126 to determine an appropriate flow threshold 107 and to increase the accuracy of the flow threshold 107. In other embodiments, the flow threshold 107 may be provided by a manufacturer and/or user definable within a given flow range.

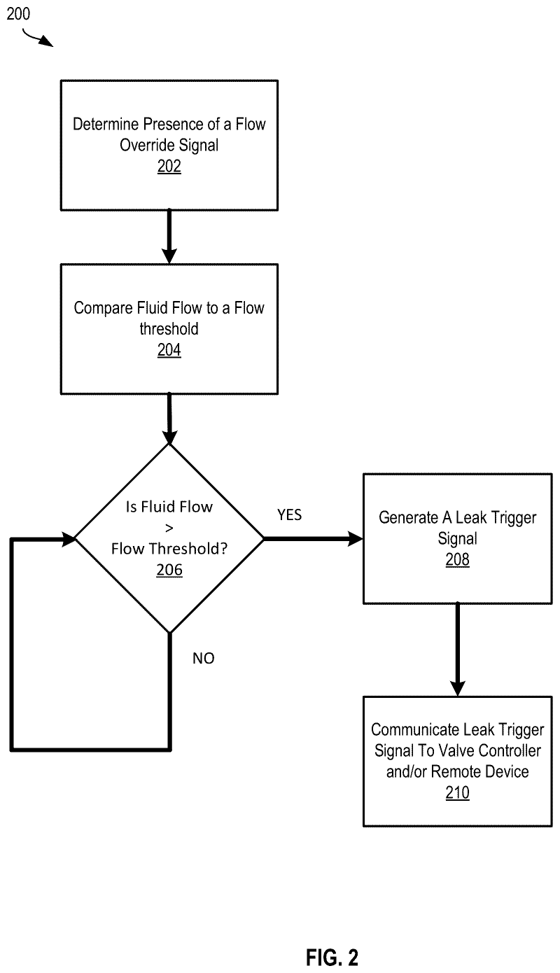

FIG. 2 illustrates a flowchart 200 of fluid leak detection operations according to one embodiment of the present disclosure. Operations of this embodiment include determining the presence of a flow override signal, indicating intentional fluid flow 202. If the flow override signal is not present, operations of this embodiment also include comparing a fluid flow to a flow threshold 204. If the fluid flow exceeds the threshold 206, operations also include generating a leak trigger signal indicative of a fluid leak 208. Operations may also include communicating the leak trigger signal to a valve controller and/or user device 210. If the fluid flow remains below the threshold 206, operations include continue comparing a fluid flow to a flow threshold 204 on a continuous or periodic basis.

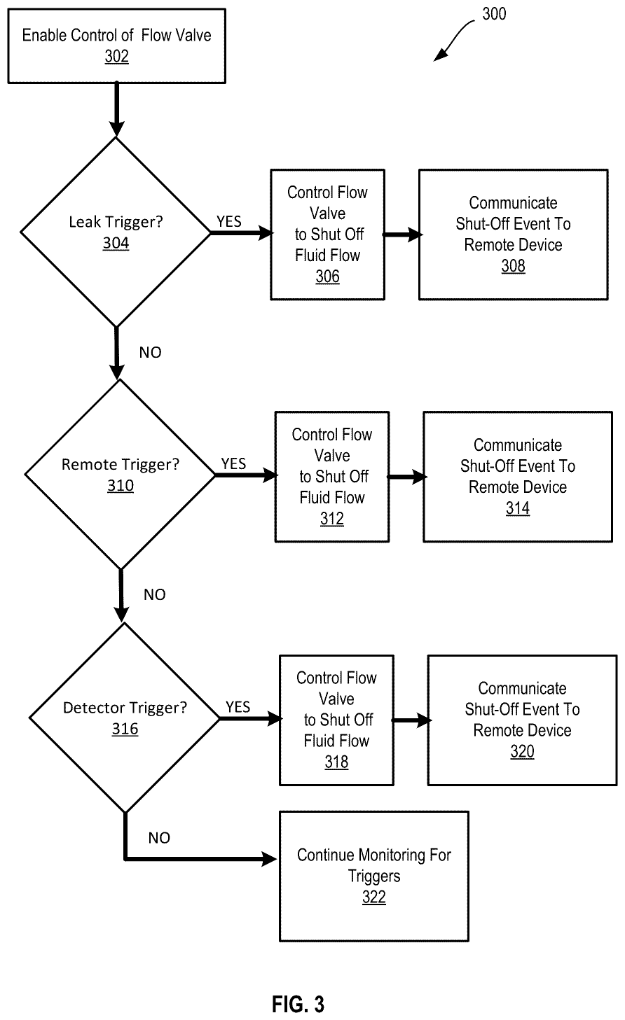

FIG. 3 illustrates a flowchart 300 of fluid shut-off operations according to one embodiment of the present disclosure. Operations of this embodiment include enabling control of a fluid flow valve 302, Operations also include determining if a leak trigger is present 304. If a leak trigger is present 304, operations also include controlling the flow valve to shut off fluid flow 306. Operations may also include communicating the shut-off event to a remote device 308. If a leak trigger is not present 304, operations also include determining if a remote trigger is present 310. If a remote trigger is present 310, operations also include controlling the flow valve to shut off fluid flow 312. Operations may also include communicating the shut-off event to a remote device 314. If a leak trigger or remote trigger is not present, operations may also include determining if a detector trigger is present 316. If a detector trigger is present 316, operations may also include controlling the flow valve to shut off fluid flow 318 and communicating the shut-off event to a remote device 320. If a leak trigger, remote trigger or detector trigger is not present, operations include continuing to monitor for triggers 322.

While FIGS. 2 and 3 illustrate various operations according to one or more embodiments, it is to be understood that not all of the operations depicted in FIG. 2 or 3 are necessary for other embodiments. Indeed, it is fully contemplated herein that in other embodiments of the present disclosure, the operations depicted in FIGS. 2 and/or 3, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

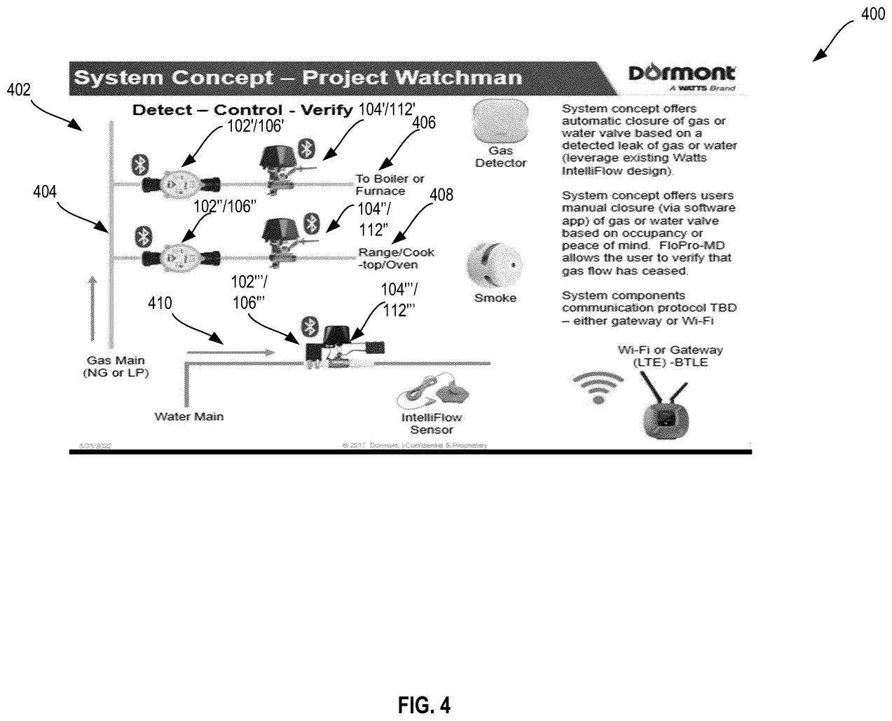

FIG. 4 illustrates example implementations 400 of a fluid flow management system according to embodiments of the present disclosure. At 402, a gas fluid system is depicted that includes a main supply line 404, a first supply branch 406 and a second supply branch 408. The first supply branch 406 includes an example flow sensor 102′/flow sensor controller 106′ and controllable flow valve 104′/valve controller 112′. Similarly, the second supply branch 408 includes an example flow sensor 102″/flow sensor controller 106″ and controllable flow valve 104″/valve controller 112″. Communications devices are include to enable communication with a remote device (not shown). In this example embodiment, the flow sensor controller 106′/106″ and valve controllers 112′/112″ may communicate with one another. If a shut-off event occurs in one supply branch (e.g., first branch 406), the flow controllers of the other branch (e.g., second branch 408) may also shut off.

At 410, a water fluid system is depicted that includes an example flow sensor 102′″/flow sensor controller 106′″ and controllable flow valve 104′″/valve controller 112′″ along a main water supply line.

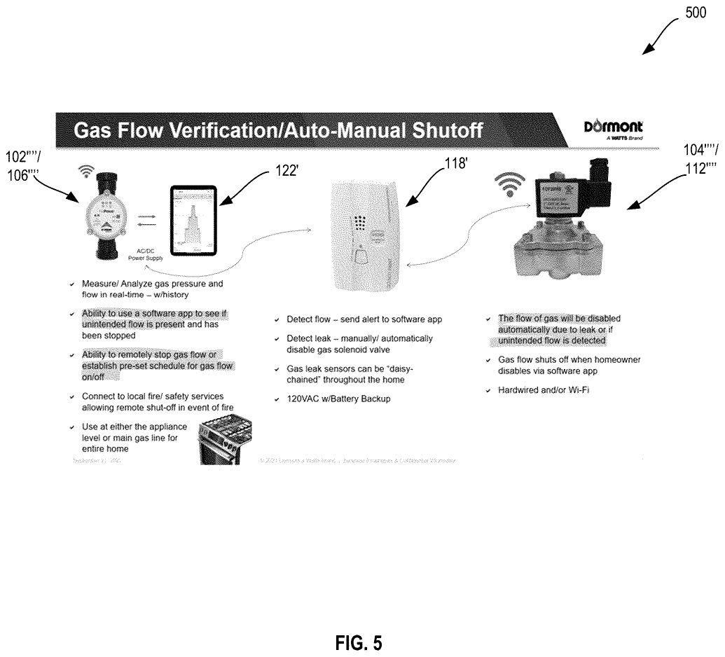

FIG. 5 illustrates another example implementation 500 of a fluid flow management system according to one embodiment of the present disclosure. In this example flow sensor 102″″/flow sensor controller 106″″ is in communication with a remote device 122′, a detector 118′ and a controllable flow valve 104″″/valve controller 112″″.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry”, as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry. The circuitry may be configured to execute code or instruction sets, and such code or instruction sets may be embodied as software, firmware, etc. Software may be embodied as a software package, code, instructions, instruction sets and/or data recorded on non-transitory, computer-readable storage devices. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

Any of the operations described herein may be implemented in a system that includes one or more non-transitory storage devices having stored therein, individually or in combination, instructions that when executed by circuitry perform the operations. Here, the circuitry may include any of the aforementioned circuitry including, for examples, one or more processors, ASICs, ICs, etc., and/or other programmable circuitry. Also, it is intended that operations described herein may be distributed across a plurality of physical devices, such as processing structures at more than one different physical location. The storage device includes any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

What is claimed:

1. A fluid flow management system, comprising:
a flow sensor coupled to a fluid source conduit and configured to determine a fluid flow in the fluid source conduit;
a flow sensor controller to compare the fluid flow to a flow threshold and generate a leak trigger signal based on the comparison of the fluid flow to the flow threshold;
a controllable valve coupled to the fluid source conduit; and
a valve controller to control the controllable valve to shut off the fluid flow in the fluid conduit based on a state of the leak trigger signal.

2. The system of claim 1, wherein the flow sensor controller further to generate the leak trigger signal based on a state of a flow override signal; wherein the flow override signal is indicative of an intentional flow of fluid.

3. The system of claim 1, wherein the fluid source comprises a gas.

4. The system of claim 3, wherein the gas comprises natural gas or liquid propane.

5. The system of claim 1, wherein the fluid source comprises water.

6. The system of claim 1, wherein the valve controller further to control the controllable valve to shut off the fluid flow in the fluid conduit based on a state of a remote trigger signal; wherein the remote trigger signal being generated by a remote device in communication with the valve controller.

7. The system of claim 1, wherein the valve controller further to control the controllable valve to shut off the fluid flow in the fluid conduit based on a state of a detector trigger signal; wherein the detector trigger signal being generated by a detector device in communication with the valve controller.

8. The system of claim 7, wherein the detector includes a smoke detector, a gas detector, a water detector, or a CO2 detector.

9. The system of claim 6, further comprising a remote user configured to communicate with the valve controller and to generate the remote trigger.

10. The system of claim 1, wherein the flow threshold is selected based on the type of fluid in the fluid conduit.

11. A method for fluid flow management, comprising:
determining a fluid flow in the fluid source conduit;
comparing the fluid flow to a flow threshold and generate a leak trigger signal based on the comparison of the fluid flow to the flow threshold; and
controlling a controllable valve to shut off the fluid flow in the fluid conduit based on a state of the leak trigger signal.

12. The method of claim 11, further comprising generating the leak trigger signal based on a state of a flow override signal; wherein the flow override signal is indicative of an intentional flow of fluid.

13. The method of claim 11, wherein the fluid source comprises a gas.

14. The method of claim 13, wherein the gas comprises natural gas or liquid propane.

15. The system of claim 11, wherein the fluid source comprises water.

16. The system of claim 11, further comprising controlling the controllable valve to shut off the fluid flow in the fluid conduit based on a state of a remote trigger signal; wherein the remote trigger signal being generated by a remote device in communication with the valve controller.

17. The system of claim 11, further comprising controlling the controllable valve to shut off the fluid flow in the fluid conduit based on a state of a detector trigger signal; wherein the detector trigger signal being generated by a detector device in communication with the valve controller.

18. The system of claim 17, wherein the detector includes a smoke detector, a gas detector, a water detector, or a CO2 detector.

19. The system of claim 16, further comprising communicating with a remote user device to generate the remote trigger.

20. The system of claim 11, wherein the flow threshold is selected based on the type of fluid in the fluid conduit.
